(19) United States
(12) Patent Application Publication
(10) Pub. No.: US 2009/0184945 A1
(43) Pub. Date: Jul. 23, 2009

(54) DRIVING METHOD OF PLASMA DISPLAY AND PLASMA DISPLAY APPARATUS

(75) Inventors: Takashi SASAKI, Hiratsuka (JP); Akihiro Takagi, Kawaguchi (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/183,300

(22) Filed: Jul. 31, 2008

(30) Foreign Application Priority Data
Jan. 22, 2008 (JP) 2008-011062

(51) Int. Cl. G09G 5/00; G09G 3/28

(52) U.S. Cl. 345/205; 345/60

(57) ABSTRACT

An erroneous address discharge in the latter address when the so-called interlace scan is performed is prevented. A period for adjusting the charge of non-lighting cells is provided after an address period in a plasma display of the address-display-period separation method. The discharge in this period is a discharge between an X electrode or an address electrode and a scan electrode, and the discharge has the same polarity as the voltages applied in the address operation, but the relative voltage is rather low, and the discharge is weaker than the address discharge of lighting cells.

### CROSS-REFERENCE TO RELATED APPLICATION

The present application claims priority from Japanese Patent Application No. JP 2008-011062 filed on Jan. 22, 2008, the content of which is hereby incorporated by reference into this application.

### TECHNICAL FIELD OF THE INVENTION

The present invention relates to a driving method of a plasma display and a plasma display apparatus used for a display apparatus of a personal computer and a work station, a flat-screen television, and a display for advertisement and information.

### BACKGROUND OF THE INVENTION

In the conventional AC color plasma display (hereinafter, abbreviated as PDP), the address-display-period separation method in which a period of specifying display cells that emit light (address period) and a display period for performing luminescent display (sustain period) are separated has been widely adopted. In this method, electric charge is accumulated in the display cells that emit light in the address period and discharge for luminescent display is performed by using the charge in the sustain period. On the other hand, the reset period is provided prior to the address period to increase the charge amount in the cells, so that the discharge in the address period can be easily generated. Consequently, much electric charge remains in the cells not discharged in the address period. Japanese Patent Application Laid-Open Publication No. 2002-14650 discloses a driving method for erasing the remaining charge.

### SUMMARY OF THE INVENTION

In this address-display-period separation method, electric charge is formed in the display cells to emit light and then discharged in the sustain period. On the other hand, since no discharge is generated in the cells not to emit light in the address period, the charge state before the address period is maintained and enters the sustain period. In many cases, this charge state has a polarity to be added to the voltage applied to each electrode in the address period. More specifically, negative charge is provided in the vicinity of the scan electrode, and positive charge is provided in the vicinity of the address electrode. At this time, in the PDP that adopts a so-called interlace scan in which a scan pulse is applied to every several scan electrodes in the address period and a multi-cycle sub-scan period is provided, erroneous address discharge occurs in the following sub-scan period.

This is because an address pulse and a scan pulse are applied in the preceding sub-scan period and a large amount of spatial charge as priming particle exists in the cells that do not emit light even if address discharge does not occur in the preceding sub-scan period. Consequently, if an address pulse is applied in this state in the following sub-scan period, the address discharge may occur and light is emitted from the cells that must not emit light.

Therefore, it is necessary to reduce spatial charge also in the cells that are not address-discharged in the preceding sub-scan period.

For the solution of the problems mentioned above, the present invention provides a driving method of a plasma display having a plurality of scan electrodes and sustain electrodes and address electrodes disposed in a direction to cross the scan electrodes and sustain electrodes, in which an address period of specifying cells to emit light by an address discharge between the address electrodes and the scan electrodes, a display sustain period of repeatedly performing discharge between the scan electrodes and the sustain electrodes to emit light from the cells, and a reset period of adjusting charge amount in the cells are provided, and the driving method of a plasma display is characterized in that the address period has N (N is a plural number) sub-scan periods, a scan pulse is applied to every predetermined number of the scan electrodes based on the N in each of the sub-scan periods, and a charge adjustment period for applying a charge adjustment pulse for generating a charge weaker than the address discharge in cells other than the cells to emit light in which address discharge is generated in a first sub-scan period is provided between the first sub-scan period and a second sub-scan period of the address period.

According to the present invention, erroneous address discharge in the so-called interlace scan can be suppressed.

### BRIEF DESCRIPTION OF THE DRAWINGS

FIG. 1A is a schematic diagram showing the configuration of a field according to the present invention;

FIG. 1B is a schematic diagram showing the configuration of a subfield according to the present invention;

FIG. 2 is an exploded perspective view showing a panel structure according to the present invention;

FIG. 3 is a configuration diagram showing a panel and a circuit configuration according to the present invention;

FIG. 4A is a waveform diagram showing an example of a driving waveform according to the first embodiment of the present invention;

FIG. 4B is a waveform diagram showing an example of a driving waveform according to the first embodiment of the present invention;

FIG. 4C is a waveform diagram showing an example of a driving waveform according to the first embodiment of the present invention;

FIG. 4D is a waveform diagram showing an example of a driving waveform according to the first embodiment of the present invention;

FIG. 4E is a waveform diagram showing an example of a driving waveform according to the first embodiment of the present invention;

FIG. 5 is a module configuration diagram according to the second embodiment of the present invention;

FIG. 6A is a waveform diagram showing an example of a driving waveform according to the third embodiment of the present invention;

FIG. 6B is a waveform diagram showing an example of a driving waveform according to the third embodiment of the present invention;

FIG. 6C is a waveform diagram showing an example of a driving waveform according to the third embodiment of the present invention;

FIG. 6D is a waveform diagram showing an example of a driving waveform according to the third embodiment of the present invention;

FIG. 6E is a waveform diagram showing an example of a driving waveform according to the third embodiment of the present invention;

FIG. 7A is a waveform diagram showing an example of a driving waveform according to the third embodiment of the present invention;

FIG. 7B is a waveform diagram showing an example of a driving waveform according to the third embodiment of the present invention;

FIG. 7C is a waveform diagram showing an example of a driving waveform according to the third embodiment of the present invention;

FIG. 7D is a waveform diagram showing an example of a driving waveform according to the third embodiment of the present invention; and

FIG. 7E is a waveform diagram showing an example of a driving waveform according to the third embodiment of the present invention.

### DESCRIPTIONS OF THE PREFERRED EMBODIMENTS

### First Embodiment

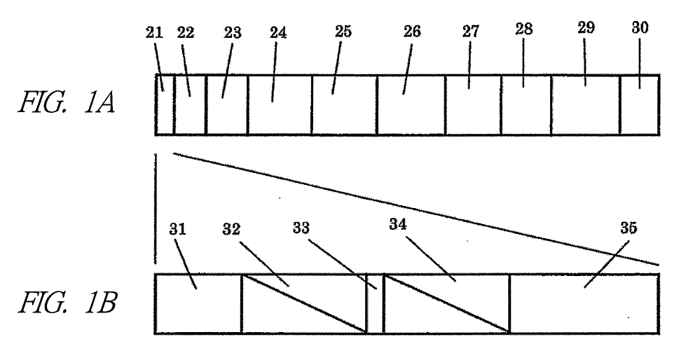

Embodiments of the present invention will be described below with reference to FIGS. 1 to 7.

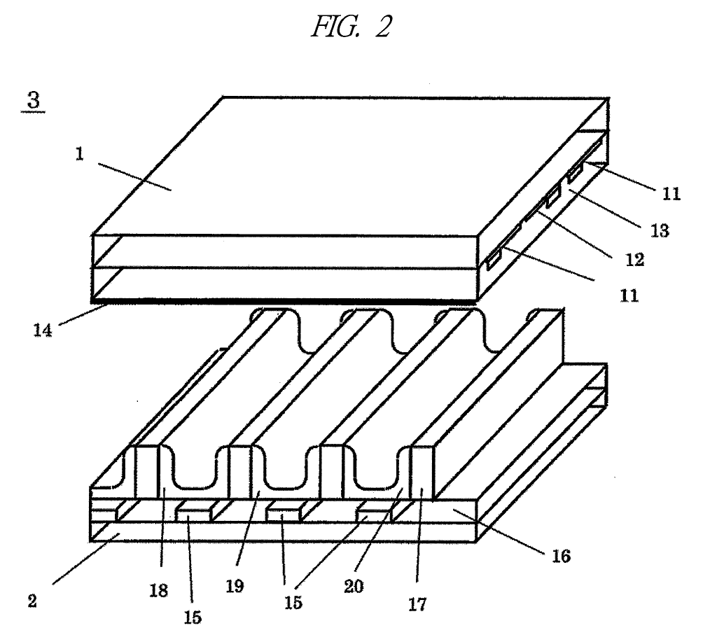

FIG. 2 is an exploded perspective view showing an example of the panel structure of the PDP according to the present invention. Sustain electrodes 11 and scan electrodes 12 for performing repetitive discharges are alternately disposed in parallel on a front plate 1. This group of electrodes is covered with a dielectric layer 13 and the surface thereof is covered with a protective layer 14 such as MgO. Address electrodes 15 are disposed on a back plate 2 in a direction approximately vertical to the sustain electrodes 11 and the scan electrodes 12 and moreover covered with a dielectric layer 16. Barrier ribs 17 are disposed on both sides of the address electrode 15 and partition the cells in a column direction. Further, phosphors 18, 19 and 20 to be excited by ultraviolet ray for emitting red (R), green (G) and blue (B) visible lights are coated on the dielectric layer 16 on the address electrode 15 and on the side surface of the barrier rib 17. After these front plate 1 and back plate 2 are laminated together so that the protective layer 14 and the barrier rib 17 come into contact, discharge gas such as Ne—Xe is filled, thereby constituting a panel.

In this structure, the scan electrode 12 selectively performs repetitive discharge with the sustain electrode 11 adjacent to one side thereof.

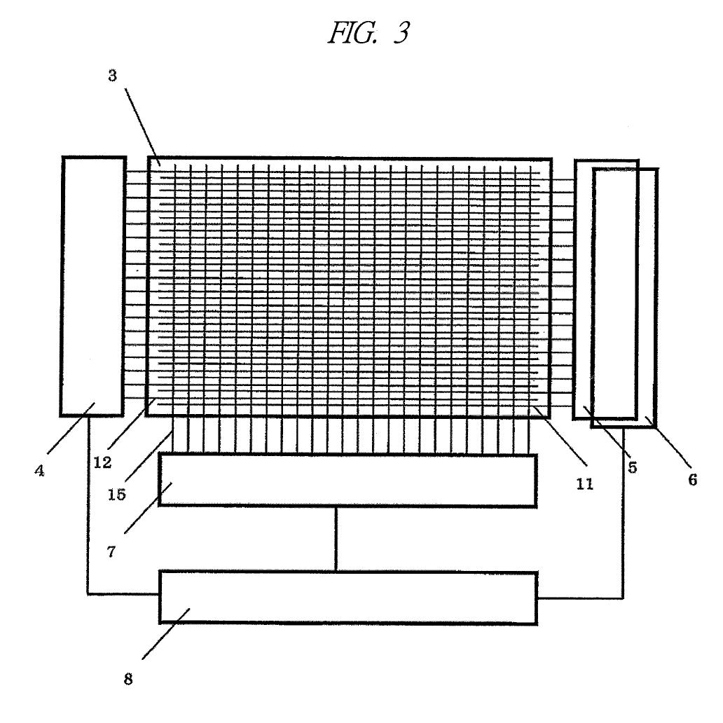

Next, the configuration of the apparatus according to the present invention will be described with reference to FIG. 3. FIG. 3 shows a PDP panel 3 constituted by laminating the front plate 1 and the back plate 2 and driving circuits. In FIG. 3, the sustain electrodes 12, the scan electrodes 11 and the address electrodes 15 of the PDP panel 3 are connected to an X electrode driving circuit 4, a Y electrode driving circuit (scan driver 5, Y driving circuit 6) and an address driving circuit 7, respectively. Moreover, respective driving circuits are controlled by a control circuit 8, and voltage is applied to each of the electrodes on the PDP panel 3.

FIG. 1 is a schematic view showing the driving method in the case of displaying a single image (1 field: 1/60 sec) and an example of the address-display-period separation method. One field is composed of a plurality of subfields (10 subfields 21 to 30 in this embodiment). Each of the subfields includes a reset period 31, a front address period 32, a charge adjustment period 33, a latter address period 34 and a sustain period 35. In the reset period 31, the charges formed in the preceding sustain period 34 are erased, and the charges in the cells are rearranged in order to support the discharges in the following address periods 32 and 34. Although there are the method in which discharges to decide the cells to emit light are performed to form the charges in the cells in the address periods 32 and 34 and the method in which charges in the cells that do not emit light are erased in the address periods 32 and 34, the present embodiment adopts the method of forming the charges in the cells to emit light. For example, the scan pulse is applied to the scan electrodes 11 of the odd-numbered rows in the front address period 32, and the scan pulse is applied to the scan electrodes 11 of the even-numbered rows in the latter address period 34.

The charge adjustment period 33 between the front address period 32 and the latter address period 34 corresponds to the characteristic feature of the present invention, in which the charges of non-selected cells (cells in which address discharges are not performed) in the preceding address period are adjusted. In the following sustain period 34, discharge is repeated to make the cells emit light. Although the address period is divided into two periods of front and latter periods in the present embodiment, it may be divided into four or other periods. In this case, scan pulse is applied to respective rows in accordance with the number of division.

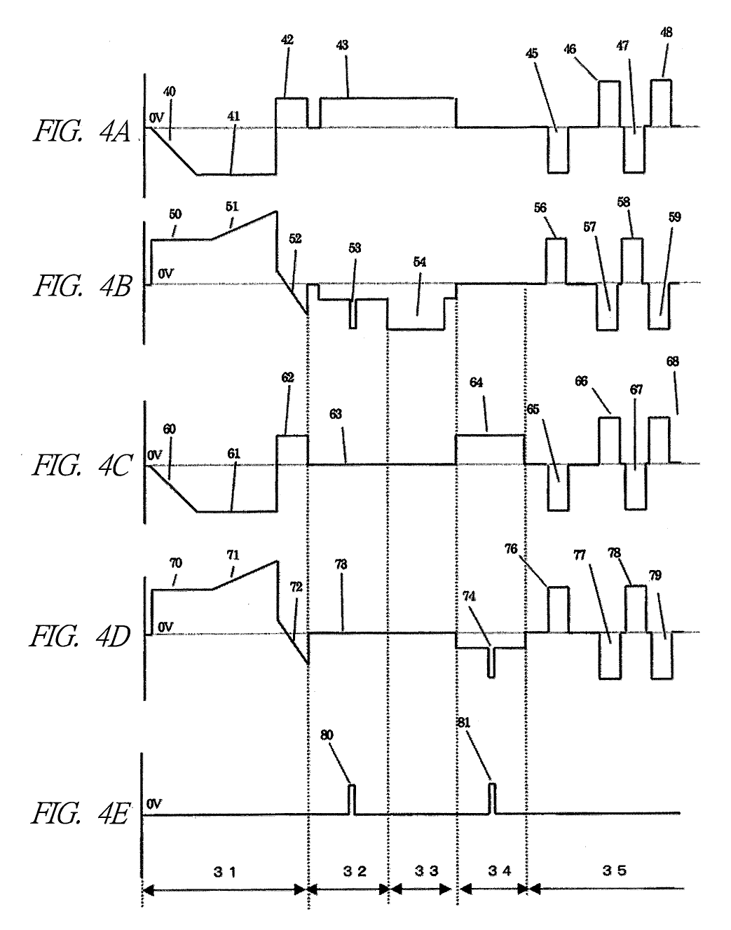

Next, FIG. 4 shows an example of driving waveforms. FIGS. 4A to 4E respectively show driving waveforms applied to each of the electrodes X1, Y1, X2, Y2 and an address electrode from the reset period to the display period. Note that the numbers added to X and Y represent the row number, and the present waveforms show the case where discharges are performed between two electrodes with the same numbers.

First, an X erase slope pulse 40 and a Y erase voltage 50 for erasing charges formed in the cells by the preceding sustain discharge are applied to X1 and Y1 electrodes of FIGS. 4A and 4B in the reset period. Subsequently, a Y write slope pulse 51 and an X voltage 41 to form charges in all cells are applied. Then, a Y compensation slope pulse 52 and an X compensation voltage 42 for erasing charges formed in the cells so as to leave the necessary amount thereof are applied.

The voltage waveforms applied in the following address period are a scan pulse 53 for the odd-numbered row for performing the discharge to decide the display cells in the row direction and an X voltage 43 for forming the charge by this discharge. This scan pulse 53 is applied by shifting the timing for each row. Then, a charge adjustment pulse 54 is applied in the charge adjustment period 33 of the present invention. In the following display period, first sustain pulses 45 and 56 and repetitive sustain pulses 46, 47, 48, 57, 58 and 59 are applied. Note that, in the present embodiment, the charge adjustment pulse 54 is designed to be applied by the scan driver 5, and the potential of the charge adjustment pulse 54 is set equal to the potential of the scan pulse 53. Also, according to the experimental results, in a state where voltage is not applied to the address electrode, the electric field between X and Y electrodes is weak and the discharge delays significantly. Therefore, the charge adjustment pulse 54 is 10 times or more longer than the scan pulse 53 and is preferably 20 to 30 μsec.

An X erase slope pulse 60 and a Y erase voltage 70 for erasing charges formed in the cells by the preceding sustain discharge are applied to X2 and Y2 electrodes of FIGS. 4C and 4D in the reset period. Subsequently, a Y write slope pulse 71 and an X voltage 61 to form charges in all cells are applied. Then, a Y compensation slope pulse 72 and an X compensation voltage 62 for erasing charges formed in the cells so as to leave the necessary amount thereof are applied.

The voltage waveforms applied in the following address period are a scan pulse 74 for the even-numbered row for performing the discharge to decide the display cells in the row direction and an X voltage 64 for forming the charge by this discharge. This scan pulse 74 is also applied by shifting the timing for each row. In the following display period, first sustain pulses 65 and 76 and repetitive sustain pulses 66, 67, 68, 77, 78 and 79 are applied.

The voltage waveforms to be applied in the address period to the address electrode 15 of FIG. 4E are address pulses 80 and 81 for performing the discharge to decide the display cells in a column direction. Note that address pulses are applied at the timing of generating the discharge in the display cells located at the intersection points of the Y electrodes 11 and the address electrodes 15 in synchronization with the scan pulse applied to each row.

Next, the discharge in this driving will be described by the driving waveforms to be applied to X1 and Y1. Note that the driving waveforms to be applied to X2 and Y2 are the same as the charge adjustment pulse 54 except for some timing, and the discharge is represented by the description of X1 and Y1. The X erase slope pulses 40 and 60 applied to the X electrodes and the Y erase voltages 50 and 70 applied to the Y electrodes erase the charges in the cells by repeatedly generating the weak discharge only in the cells in which charge is generated and formed in the preceding sustain discharge. At this time, the polarity of the charge formed at the end of the sustain discharge is (−) charge in the vicinity of the X electrode and (+) charge in the vicinity of the Y electrode, which are added to the applied voltage to generate discharge. Therefore, this discharge does not occur in the cells without the charge.

Next, the Y write slope pulse 51 applied to the Y electrode and the X voltage 41 applied to the X electrode repeatedly generate a weak discharge to form charge in the cell. At this time, since the potential difference between X and Y is sufficiently large, this discharge is generated in all cells and (−) charge is formed in the vicinity of the Y electrode and (+) charge is formed in the vicinity of the X electrode. Subsequently, the Y compensation slope pulse 52 applied to the Y electrode and the X compensation voltage 42 applied to the X electrode repeatedly generate a weak discharge and erase the charge formed in cells so as to leave the necessary amount thereof. At this time, the reached potential of the Y compensation slope pulse 52 is lower than the potential of the scan pulse 53, and the remaining charge is added to the applied voltage in the address discharge to perform the address discharge more certainly.

Next, the discharge occurs between the Y electrode and the address electrode in the cells in which the address pulse 80 is applied to the address electrode in synchronization with the scan pulse 53 applied to the Y electrode. The duration of the scan pulse 53 is normally set to about 1 to 2 μsec. In the discharge, there is a time delay between the voltage application and the actual discharge, and the scan pulse duration is set in consideration of this discharge time delay. Also, since the discharge time delay is influenced by the relative potential difference between two discharging electrodes, the relative potential difference between two electrodes generated by the address pulse and the scan pulse is set so that discharge is generated with the above-mentioned scan pulse duration. Moreover, at this time, a large electric field is formed between the Y electrode and the X electrode, and discharge is generated between the Y electrode and the X electrode. By this discharge, charges with the polarity opposite to the voltage applied to the respective electrodes are accumulated in the vicinity of the Y electrode and the X electrode. In the present embodiment, charge with (+) polarity is formed in the vicinity of the Y electrode, charge with (−) polarity is formed in the vicinity of the X electrode, and charge with (−) polarity is formed in the vicinity of the address electrode. When the charge with the same polarity as the voltage applied to each electrode vicinity when generating the address discharge is formed in advance, the address discharge can be surely generated. Therefore, in the reset period 31 shown in FIG. 1, the charge with (−) polarity may be formed in the vicinity of the Y electrode, and the charge with (+) polarity may be formed in the vicinity of the X electrode and in the vicinity of the address electrode. In the cells where address discharge does not occur, this charge is held until the next discharge is generated.

The charge adjustment pulse 54 with (−) polarity is applied to the Y electrode in the charge adjustment period 33. As mentioned above, in the display cell, charge with (+) polarity is formed in the vicinity of the Y electrode, charge with (−) polarity is formed in the vicinity of the X electrode and charge with (−) polarity is formed in the vicinity of the address electrode by the address discharge. Therefore, the applied voltage of the charge adjustment pulse is canceled, and discharge does not occur in the cell. On the other hand, since charge with (−) polarity is formed in the vicinity of the Y electrode, charge with (+) polarity is formed in the vicinity of the X electrode and charge with (+) polarity is formed in the vicinity of the address electrode in the non-display cells, the charges are added to the applied voltage of the charge adjustment pulse, and a weak discharge is generated in the non-display cell. At this time, since the relative potential between the Y electrode and the address electrode or the X electrode is lower than the relative potential for generating discharge, the discharge time delay becomes larger. In the experiment, almost no discharge is generated with the pulse duration of 5 μsec. The discharge is generated with the pulse duration of 10 μsec, but the pulse duration sometimes exceeds this time duration due to the variations. The discharge is almost generated with the pulse duration of 20 μsec. As described above, the duration of the charge adjustment pulse is necessarily equal to or more than 20 μsec and preferably equal to or less than 30 μsec in order to prevent the address period from being long. However, in the case where the relative potential between two electrodes is made higher, since the delay becomes smaller, the duration of the charge adjustment pulse can be reduced, but charge with (+) polarity formed in the vicinity of the Y electrode increases, which raises the possibility of erroneous lighting of the non-display cells. On the contrary, in the case where the relative potential between two electrodes is made lower, since the delay becomes larger, it is necessary to increase the duration of the charge adjustment pulse, but the possibility that the discharge does not occur also becomes higher undesirably. Hence, the selectable voltage range of the relative potential is not so wide, and the duration of the charge adjustment pulse is preferably equal to or more than 20 μsec and equal to or less than 30 μsec as mentioned above.

Thereafter, address voltage is also applied to the cells on the odd-numbered rows when the address pulse corresponding to the latter scan is applied, but erroneous discharge will not occur because charge has decreased in the non-display cells.

Next, in the display period, a first sustain discharge occurs by the first sustain pulses 45 and 56 by the use of the charge formed in the cell in which the address discharge is generated. By this discharge, charge with (−) polarity is formed in the vicinity of the Y electrode and charge with (+) polarity is formed in the vicinity of X the electrode of the discharged cell. Next, by repeating the repetitive sustain pulses 46, 47, 48, 57, 58 and 59, discharge is repeatedly performed while inverting the charges.

As mentioned above, by providing the period 33 for adjusting the remaining charge of the non-lighting cells between the front address period 32 and the latter address period 34 to reduce the spatial charge of the non-lighting cells, a driving capable of reducing the erroneous discharge in the latter address can be performed.

### Second Embodiment

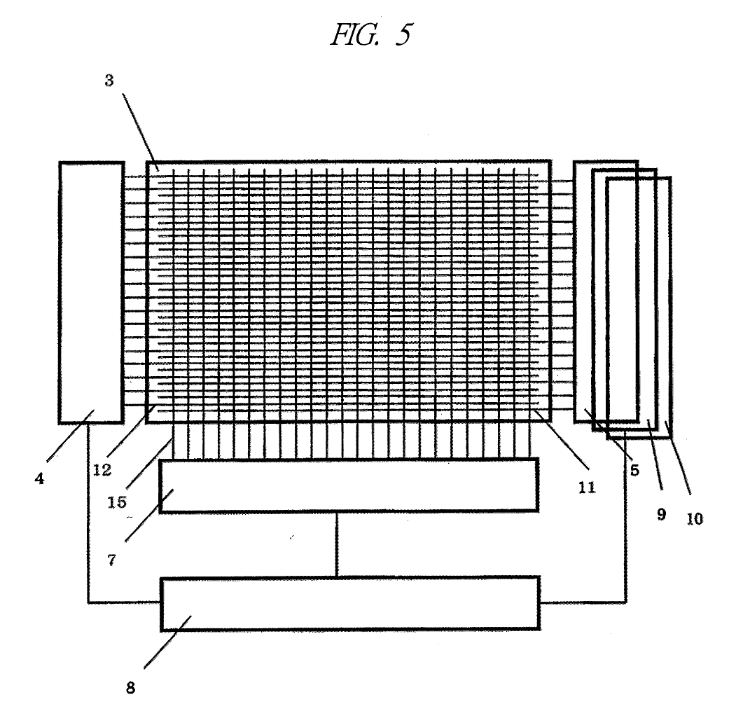

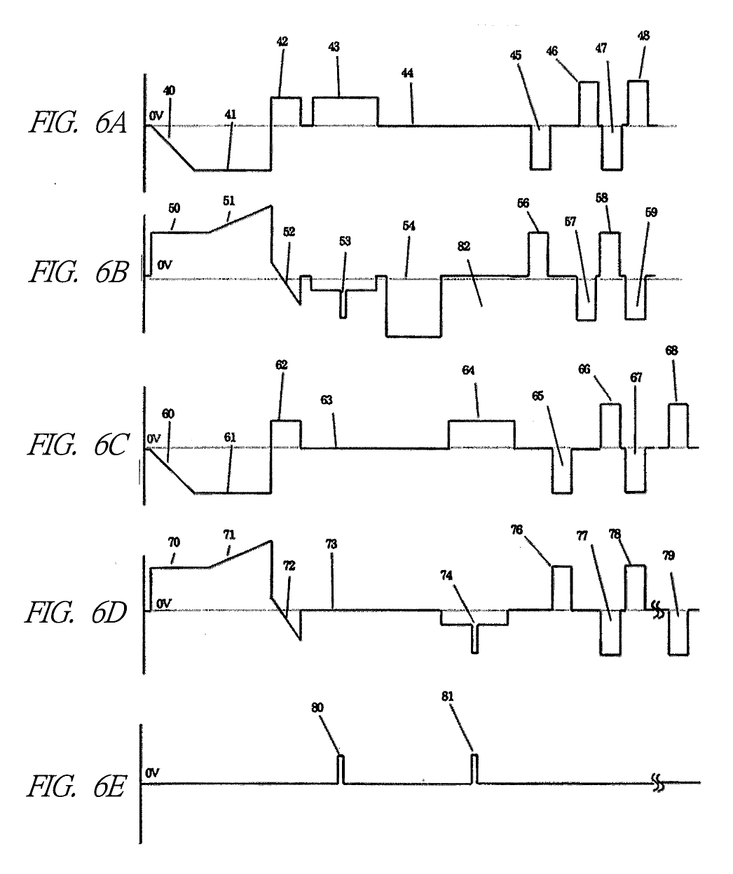

Next, the second embodiment of the present invention will be described with reference to FIGS. 5 and 6.

FIG. 5 is a module configuration diagram according to a second embodiment of the present invention. In this embodiment, a Y odd-numbered row driving circuit 9 for applying voltage to the electrodes of odd-numbered rows and a Y even-numbered row driving circuit 10 are provided for the Y electrodes. The PDP panel 3, the X electrode driving circuit 4, the scan driver 5, the address driving circuit 7 and the control circuit 8 other than these are similar to those of the first embodiment, and the detail description thereof will be omitted. The Y odd-numbered row driving circuit 9 and the Y even-numbered row driving circuit 10 are the circuits that can apply the voltage commonly to the Y electrodes of odd-numbered rows and the Y electrodes of even-numbered rows, respectively, and are configured to apply different voltage waveforms to the odd-numbered rows and the even-numbered rows.

In FIG. 6, different from the first embodiment, the charge adjustment pulse 54 is not applied by the scan driver, but applied to the Y electrodes on the odd-numbered row by the Y odd-numbered row driving circuit 9. With regard to the waveform, a potential is made lower compared with the first embodiment shown in FIG. 4 (higher in the absolute value) to increase the relative potential between the Y electrode and the address electrode. Other driving waveforms for the reset period, the address period and the sustain period are similar to those of the first embodiment and the description thereof will be omitted by attaching the same symbols.

With this charge adjustment pulse 54, the potential difference between the X or address electrode and the Y electrode becomes higher compared with the first embodiment, and the charge remaining in the non-lighting cells can be reduced. In this manner, the driving capable of reducing the erroneous discharge in the latter address can be achieved.

### Third Embodiment

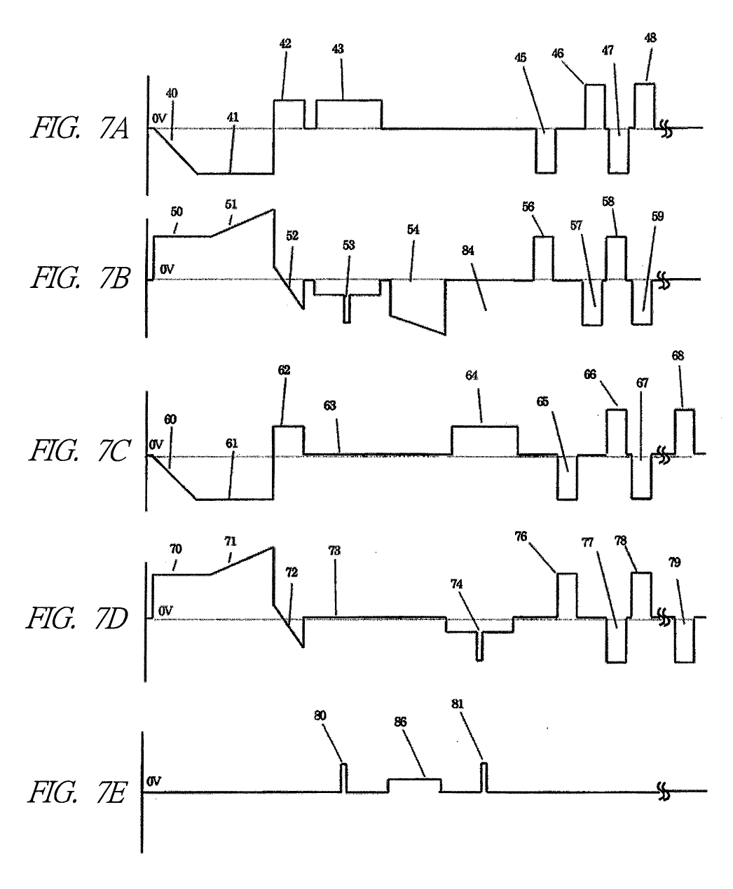

Next, the third embodiment of the present invention will be described with reference to FIG. 7.

The module is schematically configured to apply different voltage waveforms to the Y electrodes on the odd-numbered rows and the even-numbered rows similarly to the second embodiment shown in FIG. 5. In FIG. 7, a pulse 86 is applied to the address electrode simultaneously with the charge adjustment pulse 54, and at the same time, the potential is set lower (higher in the absolute value) than the scan pulse similarly to the second embodiment shown in FIG. 6. On the other hand, since the potential of the charge adjustment pulse 54 of the present embodiment becomes continuously lower (higher in the absolute value) in the negative direction, a weak discharge is generated between the Y electrode and the address electrode or the X electrode, thereby reducing the charge. Other driving waveforms for the reset period, the address period and the sustain period are similar to those of the first embodiment, and the description thereof will be omitted by attaching the same symbols. Also in this case, the charge remaining in the non-lighting cells can be reduced. In this manner, the driving capable of reducing the erroneous discharge in the latter address can be achieved.

What is claimed is:

1. A driving method of a plasma display, the plasma display having a plurality of scan electrodes and sustain electrodes and address electrodes disposed in a direction to cross the scan electrodes and sustain electrodes, in which an address period of specifying cells to emit light by an address discharge between the address electrodes and the scan electrodes, a display sustain period of repeatedly performing discharge between the scan electrodes and the sustain electrodes to emit light from the cells, and a reset period of adjusting charge amount in the cells are provided,
wherein the address period has N (N is a plural number) sub-scan periods,
a scan pulse is applied to every predetermined number of the scan electrodes based on the N in each of the sub-scan periods, and
a charge adjustment period for applying a charge adjustment pulse for generating a charge weaker than the address discharge in cells other than the cells to emit light in which address discharge is generated in a first sub-scan period is provided between the first sub-scan period and a second sub-scan period of the address period.

2. The driving method of a plasma display according to claim 1,
wherein the charge adjustment pulse is applied to all of the scan electrodes to which the scan pulse is applied in the first sub-scan period and has the same potential as the scan pulse and longer duration than the scan pulse.

3. The driving method of a plasma display according to claim 2,
wherein the pulse duration of the charge adjustment pulse is equal to or more than 20 μsec and equal to or less than 30 sec.

4. The driving method of a plasma display according to claim 1,
wherein the charge adjustment pulse is applied to all of the scan electrodes to which the scan pulse is applied in the first sub-scan period and has a slope waveform in which potential is continuously lowered to the same potential as the scan pulse.

5. A plasma display apparatus having a plurality of scan electrodes and sustain electrodes and address electrodes disposed in a direction to cross the scan electrodes and sustain electrodes, in which an address period of specifying cells to emit light by an address discharge between the address electrodes and the scan electrodes, a display sustain period of repeatedly performing discharge between the scan electrodes and the sustain electrodes to emit light from the cells, and a reset period of adjusting charge amount in the cells are provided,
the plasma display apparatus comprising:
a scan electrode driving circuit, a sustain electrode driving circuit, and an address electrode driving circuit for driving the scan electrodes, the sustain electrodes and the address electrodes, respectively; and
a control circuit for controlling the scan electrode driving circuit, the sustain electrode driving circuit, and the address electrode driving circuit,
wherein, in each sub-scan period obtained by dividing the address period into N (N is a plural number) periods, the control circuit controls the scan electrode driving circuit so as to apply a scan pulse to every predetermined number of the scan electrodes based on the N, and
the control circuit controls the scan electrode driving circuit so that a charge adjustment pulse for generating a charge weaker than the address discharge in cells other than the cells to emit light in which address discharge is generated in a first sub-scan period is applied between the first sub-scan period and a second sub-scan period of the address period.

6. The plasma display apparatus according to claim 5,
wherein the charge adjustment pulse is applied to all of the scan electrodes to which the scan pulse is applied in the first sub-scan period and has the same potential as the scan pulse and longer duration than the scan pulse.

7. The plasma display apparatus according to claim 6,
wherein the pulse duration of the charge adjustment pulse is equal to or more than 20 μsec and equal to or less than 30 μsec.

8. The plasma display apparatus according to claim 5,
wherein the charge adjustment pulse is applied to all of the scan electrodes to which the scan pulse is applied in the first sub-scan period and has a slope waveform in which potential is continuously lowered to the same potential as the scan pulse.
